(19) United States
(12) Patent Application Publication
(10) Pub. No.: US 2014/0230026 A1
(43) Pub. Date: Aug. 14, 2014

(54) Biometric-Based Access Control System Comprising a Near Field Communication Link

(71) Applicant: James D. Forero, Paramus, NJ (US)

(72) Inventor: James D. Forero, Paramus, NJ (US)

(21) Appl. No.: 13/794,799

(22) Filed: Mar. 12, 2013

Related U.S. Application Data
(60) Provisional application No. 61/763,516, filed on Feb. 12, 2013.

(51) Int. Cl. H04W 12/08; H04W 12/06; H04L 29/06

(52) U.S. Cl. CPC H04W 12/08; H04L 63/0861; H04W 12/06
USPC 726/5

(57) ABSTRACT

The subject invention is directed to a class of biometric-based authentication methods and devices that can be utilized to control access to any electronic device or electronically-controlled device. Certain embodiments include a touch sensitive device including a transparent input device (e.g., a touchscreen) or opaque input device (e.g., a touchpad). Some examples of electronic devices include cellular phones, smart phones, laptop computers, tablet computers, gaming consoles, and the like. Some examples of electronically-controlled devices include computer numerical control (CNC) milling machines, vehicles, and the like.

This application is entitled to the priority date of Feb. 12, 2013 for all material previously included in the following Provisional Applications and Utility Patent Applications:
U.S. provisional patent application No. 61/663,561, titled “Biometric Authentication Methods Based on Touch Sensitive Device Input,” filed Jun. 23, 2012,
U.S. provisional patent application No. 61/663,563, titled “Biometric Authentication Methods Based on Analysis of Eigenrotation Gestures Made by Fingers,” filed Jun. 23, 2012,
U.S. utility patent application Ser. No. 13/531,550, titled “Biometrics-Based Methods for User Authentication,” filed Jun. 24, 2012,
U.S. provisional patent application No. 61/696,822, titled “Virtual Tokens for User Authentication,” filed Sep. 5, 2012,
U.S. provisional patent application No. 61/703,748, titled “Granting Access to Hardware, Software or Website by First User to Second User,” filed Sep. 20, 2012,
U.S. provisional patent application No. 61/704,503, titled “User Authentication Using, Electrical, Magnetic, or Electromagnetic Biosigns,” filed Sep. 23, 2012,
U.S. provisional patent application No. 61/745,612, titled “Control of Electronic Devices and Biometric Authentication Based on Analysis of Circle Like Touch Gestures,” filed Jun. 23, 2012, and
U.S. provisional patent application No. 61/763516, titled “User Biometric Authentication to Control Electronic User Devices via Near Field Communication,” filed Feb. 12, 2013, which are all hereby incorporated by reference in the instant application in their entireties.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present disclosure relates generally to the technical field of biometric-based control of restricted functionalities. More specifically, it relates to methods and devices for access control that comprise authentication techniques and wireless control links to the controlled device or system. Still more specifically, it relates to the use of near field communication (NFC) to implement the wireless control link.

In recent years, the push toward mobile electronic access to data and controlled access systems has become a tsunami. The operations of an entire business can be carried out from a smartphone application, locks and keys have become remotely controlled electronic systems, and access to personal finance management is generally protected by a single password.

There is no perfect system for controlling access to restricted and/or dangerous assets, but it is clear to most people that the current system of password-based access control systems is both awkward in operation and risky in practice.

### SUMMARY OF THE INVENTION

The subject invention was developed to address the inadequacies and risks associated with password-based access control systems, and to do so in a quick, convenient, and mobile system comprising biometric-based user authentication and control of the authentication process and access to the desired system or device by methods comprising wireless communication. In a particular embodiment of the instant invention, the wireless communication would comprise a near field transmission link.

Certain aspects of the subject invention are set forth below. It should be understood that the aspects shown and discussed are not requesting to limit or exhaust the scope of the invention.

### BRIEF DESCRIPTION OF THE DRAWINGS

FIG. 1 shows a high level diagram of a first class of implementation of a biometric-based access control system according to the instant invention.

FIG. 2 shows a high level diagram of a second class of implementation of a biometric-based access control system according to the instant invention.

FIG. 3 shows a high level diagram of a third class of embodiments of a biometric-based access control system according to the instant invention.

FIG. 4 shows a high level diagram of a fourth class of embodiments of a biometric-based access control system according to the instant invention.

### DETAILED DESCRIPTION OF THE INVENTION

A common aspect to many embodiments of the present invention is the methods used to enable an authentication unit to analyze the biometric signature of a user and to make an authentication decision therefrom. A typical sequence is described below, and is based largely upon the matter included by reference in paragraph [0001]. However, the present invention is not requesting to be limited to these specific approaches to biometric authentication.

In operation of the instant invention, a user is to make one or more touch gestures on a touch sensitive device (e.g., a touchscreen). Responsive to the touch gesture, the touch sensitive device detects user biometric information unique to the requesting user.

The user biometric information may comprise dynamic information, such as an array of coordinate values corresponding to the touch gesture, an array of pressure values corresponding to the pressure used by the requesting user to make the touch gesture, coordinate and pressure arrays that also include the time history, keystroke dynamics, motion dynamics or patterns, and the like. The user biometric information may also comprise static information, such as the finger widths and lengths of the user, user hand outline images, fingerprints, face, iris, or retinal images, and any other biometric electronic, resistive, capacitive, or other signals.

Once the user biometric information is acquired, a user feature vector that summarizes the biometric information according to a specific authorization scheme may be calculated, which may be then compared to feature vectors of the authorized (or unauthorized) users to determine if the user feature vector is sufficiently similar to one of the authorization feature vectors to allow access.

The similarity between two feature vectors can be determined using one or more machine learning algorithms such as neural networks algorithms, heuristic algorithms, support vector machine algorithms, k-nearest neighbor (k-NN) algorithms, and so forth. Further, based on the determination of the similarity, an authentication decision can be made with respect to the user.

Once a positive authentication decision is made regarding a requesting user, an electronic device can be instructed to generate a control command for a peripheral electronic device. The control command is then wirelessly transmitted to the peripheral electronic device. In an example, the wireless transmission may take place through any suitable means, said means comprising a Near Field Communication (NFC) scheme, either according to ISO/IEC standards 18092/ECMA-340 and/or 21481/ECMA-352, or by any other Near Field Communication system. Other embodiments of the instant invention may implement the wireless transmission using IEEE 802.11 communication schemes, Bluetooth communication schemes, ISM RF broadcast, and so forth. Note that NFC transmits information using magnetic induction, which is a subset of electromagnetic radiation.

The peripheral electronic device may include any suitable electronic device configured to receive and process wireless signals. Some examples of peripheral electronic devices may include a mobile device, cellular phone, smart phone, computer, point-of-sale machine, payment terminal, electronic door lock, vehicle or home security system, vehicles, intercom, gaming device, CNC machining equipment, and so forth.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer executable instructions residing on a storage medium such as a disk drive, or computer-readable medium. It should be noted that methods disclosed herein can be implemented by a computer (e.g., a desktop computer, tablet computer, laptop computer), game console, handheld gaming device, cellular phone, smart phone, smart television system, and so forth.

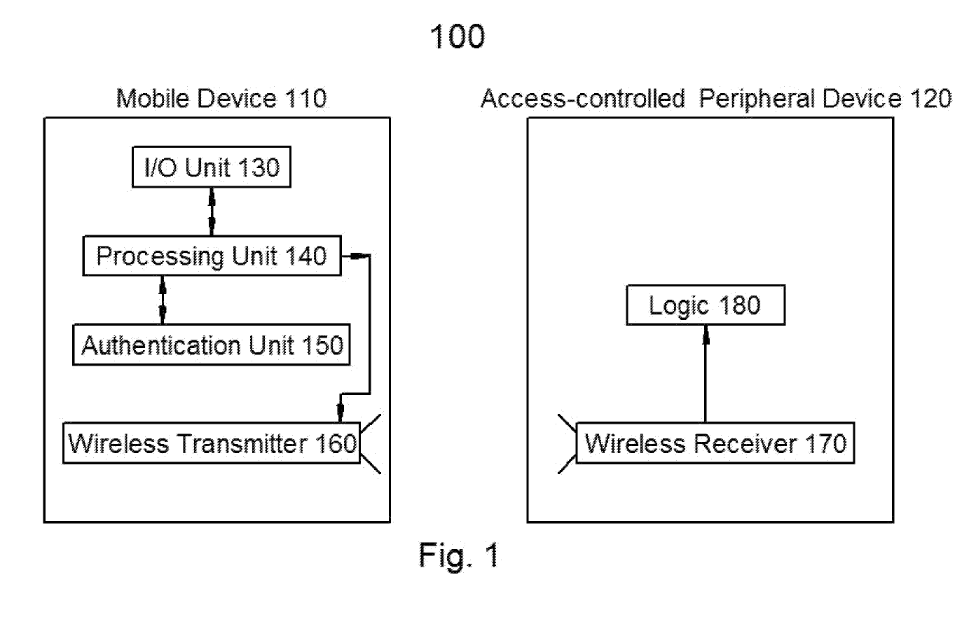

FIG. 1 shows a high level diagram of an embodiment 100 of the claimed invention. As shown in the figure, there appear mobile device 110 (e.g., a smart phone) and access-controlled peripheral device 120 (e.g., an electronic door lock). Mobile device 110 may include input/output unit 130. Input/output unit 130 may comprise a touchscreen, touchpad, keypad, image sensor, or other input sensors. The mobile device 110 may also have a processing unit 140 including memory (not shown) for storing processor-implementable instructions and data to perform the methods disclosed herein. The processing unit 140 may have a virtual or physical authentication unit 150. In this implementation, the processing unit communicates access-control information to peripheral device 120 via wireless transmitter 160. In a specific implementation, wireless transmitter 160 uses near field communication to carry out this communication.

Access-controlled peripheral device 120 receives at least one access-control instruction through wireless receiver 170 and transmits it to logic 180. The logic 180 reads said at least one access-control instruction and responds appropriately. Said at least one access-control instruction can comprise an access code, an instruction to carry out a specific operation, an order to lock out all users, raw biometric data about the user, summarized biometric data about the user, the user feature vector, or other information relevant to access control functions.

In operation, a requesting user can operate the input/output unit 130 to generate inputs that include user biometric information. These inputs are then transmitted in the form of electronic signals to the authentication unit 150. The user input can be processed to extract user biometric information in a summary form (typically a feature vector) which can be usefully compared by authentication unit 150 with a local or remote database of access-approved biometric information (typically feature vectors of authorized users).

Once user authentication is performed and the user is successfully authenticated, the processing unit 140 may generate a command (e.g., a predetermined command or command associated with the user input) to be wirelessly transmitted by the wireless transmitter 160 to the peripheral device 120 (e.g., the door lock). Said command may instruct peripheral device 120 to carry out a function (e.g., unlock a door), or to allow the user access to functional controls for peripheral device 120 (not shown). Unsuccessful authentication may result in actions comprising denial of access, reporting the attempt to a central monitor (not shown), locking down the functionality of peripheral device 120, or any other action desired.

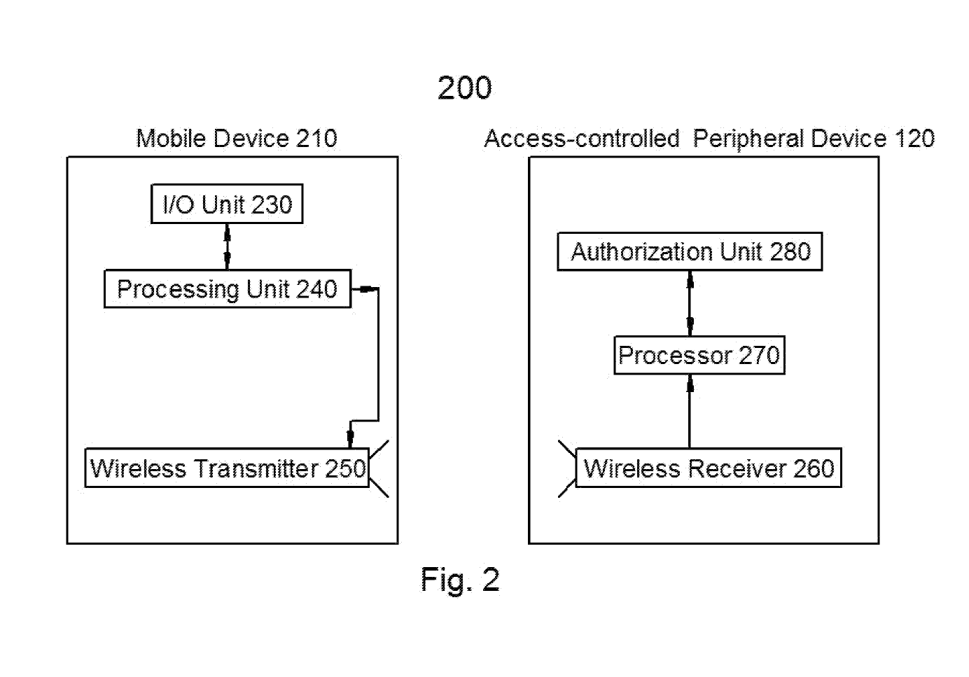

FIG. 2 shows a high level diagram of an embodiment 200 of the claimed invention. As shown in the figure, there appears a mobile device 210 (e.g., a smart phone) and an access-controlled peripheral device 220 (e.g., an electronic door lock). Mobile device 210 may include input/output unit 230. Input/output unit 230 may comprise a touchscreen, touchpad, keypad, image sensor, or other input sensors. The mobile device 210 may also have a processing unit 240 including memory (not shown) for storing processor-implementable instructions and data to perform the methods disclosed herein.

In operation, a requesting user can operate the input/output unit 230 to generate user input that include user biometric information. User input is then transmitted in the form of electronic signals to processing unit 240. User input can be processed therein to prepare a user biometric description. The user biometric description may comprise the user input, user biometric information, summary user biometric information (typically a feature vector), or any other data relating to the biometric description of the requesting user.

Once the user biometric description is generated, processing unit 240 communicates user summary biometric description to peripheral device 220 via wireless transmitter 250. In a specific embodiment, wireless transmitter 250 uses near field communication to carry out this communication.

Access-controlled peripheral device 220 receives the user biometric description through wireless receiver 260 and transmits it to processor 270. Processor 270 records the user biometric description, and extracts therefrom user summary biometric information. Said extraction may comprise further processing of the user biometric description.

Processor 270 then communicates the user summary biometric information to authorization unit 280. Authorization unit 280 can usefully compare the user summary biometric information with a local or remote database of access-approved summary biometric information (typically feature vectors of authorized users).

If authorization unit 280 confirms the identity and authorization of the requesting user, it signals processor 270 to cause the peripheral device 220 to perform an operation (e.g., unlock the door), to allow the requesting user the level of access to which he is entitled, or any other action. If authorization unit 280 does not confirm the identity and authorization of the requesting user, it signals processor 270 to initiate actions comprising rejection of the desired operation, reporting the unsuccessful authorization attempt, locking down peripheral device 220, or any other action desired.

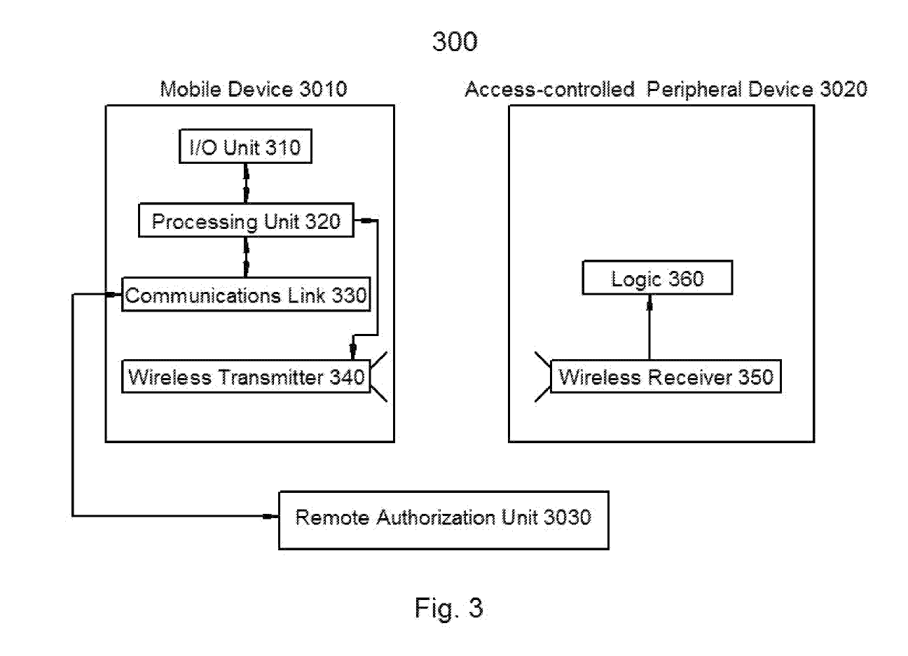

FIG. 3 shows a high level diagram of an embodiment 300 of the claimed invention. As shown in the figure, there appears a mobile device 3010 (e.g., a smart phone), an access-controlled peripheral device 3020 (e.g., an electronic door lock), and a remote authorization unit 3030. Mobile device 3010 may include input/output unit 310. Input/output unit 310 may comprise a touchscreen, touchpad, keypad, image sensor, or other input sensors. The mobile device 3010 may also have a processing unit 320 including memory (not shown) for storing processor-implementable instructions and data to perform the methods disclosed herein.

In operation, a requesting user can operate the input/output unit 310 to generate user input that include user biometric information. User input is then transmitted in the form of electronic signals to processing unit 320. User input can be processed therein to prepare a user biometric description. The user biometric description may comprise the user input, user biometric information, summary user biometric information (typically a feature vector), or any other data relating to the biometric description of the requesting user.

Once the user biometric description is generated, processing unit 320 communicates user summary biometric description to remote authorization unit 3030 via a communications link 330.

Remote authorization unit 3030 receives the user biometric description through communications link 330. Remote authorization unit 3030 then carries out actions comprising usefully comparing the user biometric description with a database of access-approved summary biometric information (typically feature vectors of authorized users). Unit 3030 then transmits its confirmation or denial of the identity and authorization of the requesting user to processing unit 320 via communications link 330.

If remote authorization unit 3030 confirms the identity and authorization of the requesting user, processor 320 is transmits a signal to logic 360 of peripheral device 3020, via wireless transmitter 340 and wireless receiver 350, to cause the peripheral device 3020 to perform an operation (e.g., unlock the door), to allow the requesting user the level of access to which he is entitled, or any other action.

If remote authorization unit 3030 does not confirm the identity and authorization of the requesting user, processor 320 transmits a signal to logic 360 of peripheral device 3020, via wireless transmitter 340 and wireless receiver 350, to cause peripheral device 3020 to initiate actions comprising rejection of the desired operation, reporting the unsuccessful authorization attempt, locking down peripheral device 3020, or any other action desired.

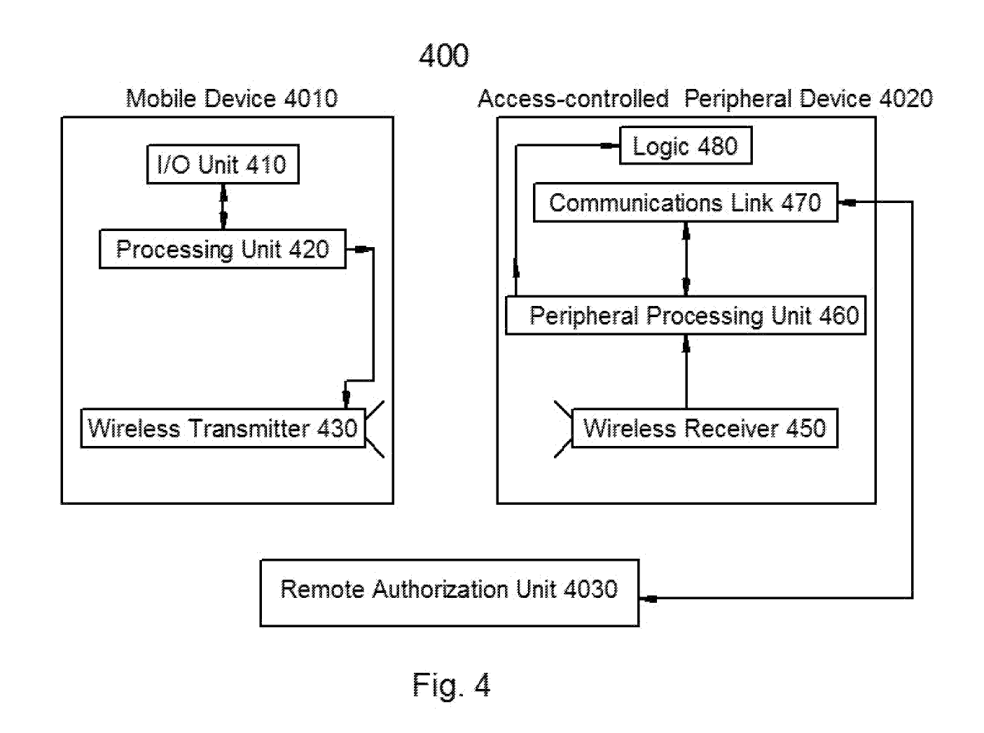

FIG. 4 shows a high level diagram of an embodiment 400 of the claimed invention. As shown in the figure, there appears a mobile device 4010 (e.g., a smart phone), an access-controlled peripheral device 4020 (e.g., an electronic door lock), and a remote authorization unit 4030. Mobile device 4010 may include input/output unit 410. Input/output unit 410 may comprise a touchscreen, touchpad, keypad, image sensor, or other input sensors. The mobile device 4010 may also have a processing unit 420 including memory (not shown) for storing processor-implementable instructions and data to perform the methods disclosed herein.

In operation, a requesting user can operate the input/output unit 410 to generate user input that include user biometric information. User input is then transmitted in the form of electronic signals to processing unit 420. User input may be processed therein to prepare a user biometric description. The user biometric description may comprise the user input, user biometric information, summary user biometric information (typically a feature vector), or any other data relating to the biometric description of the requesting user.

Once the user biometric description is generated, processing unit 420 communicates at least the user biometric description to peripheral processing unit 460 in peripheral device 4020 via wireless transmitter 430 and wireless receiver 450. Peripheral processing unit 460 then transmits at least the user biometric description to remote authorization unit 4030 via communications link 470.

Remote authorization unit 4030 then carries out actions comprising usefully comparing the user biometric description with a database of access-approved summary biometric information (typically feature vectors of authorized users). Unit 4030 then transmits its confirmation or denial of the identity and authorization of the requesting user to peripheral processing unit 460 via communications link 470.

If remote authorization unit 4030 confirms the identity and authorization of the requesting user, peripheral processor 460 transmits a signal to logic 480 of peripheral device 4020 to cause peripheral device 4020 to perform an operation (e.g., unlock the door), to allow the requesting user the level of access to which he is entitled, or any other action.

If remote authorization unit 4030 does not confirm the identity and authorization of the requesting user, peripheral processor 460 transmits a signal to logic 480 of peripheral device 4020 to cause peripheral device 4020 to initiate actions comprising rejection of the desired operation, reporting the unsuccessful authorization attempt, locking down peripheral device 4020, or any other action desired.

While the foregoing written description of the instant invention enables one of ordinary skill to make and use what is considered to be the best mode thereof, those of ordinary skill will also understand and appreciate the existence of variations, combinations, and equivalents of the specific embodiment, method, and examples herein. The invention is therefore not intended to be limited by the above described embodiments, methods, and examples, but by all embodiments and methods within the scope and spirit of the invention as claimed below.

1. A method for controlling access by a requesting user to a peripheral device comprising a wireless receiver, comprising:
acquiring, by operation of a touch sensitive unit on a mobile device comprising a wireless transmitter, user input;
extracting, by one or more processing units, user biometric information from at least said user input;
evaluating, by said one or more processing units, the degree of similarity of the user biometric information with at least one database comprising access-approved biometric information;
making, by said one or more processing units, an authorization decision with respect to the requesting user based on said degree of similarity;
generating, by said one or more processing units, a command corresponding to the user input; and
transmitting said command via said wireless transmitter to said peripheral device comprising a wireless receiver via said wireless receiver.

2. The method of claim 1, wherein said touch sensitive unit comprises at least one touch sensitive device chosen from the group consisting of a touchscreen, a touchpad, an electronic pen, an accelerometer, and a digitizing tablet.

3. The method of claim 1, wherein said mobile device comprises at least one mobile unit chosen from the group consisting of a cellular phone, portable computer, a tablet computer, a laptop computer, a remote control, and an electronic pen.

4. The method of claim 1, wherein evaluating the degree of similarity is carried out using one or more machine-learning algorithms.

5. The method of claim 4, wherein at least one of said one or more machine-learning algorithms is chosen from the group consisting of neural networks algorithms, heuristic algorithms, support vector machine algorithms, and k-nearest neighbor (k-NN) algorithms.

6. The method of claim 1, wherein said wireless transmitter transmits information using electromagnetic radiation and said wireless receiver receives said information.

7. The method of claim 6, wherein said electromagnetic radiation comprises frequencies ranging between roughly 3 kiloHertz and 300 gigaHertz.

8. The method of claim 6, wherein said electromagnetic radiation comprises wavelengths ranging between roughly 0.1 and 10 microns.

9. The method of claim 1, wherein said wireless transmitter transmits to said wireless receiver using at least one protocol chosen from the group consisting of near field communication, IEEE 802.11, Bluetooth, and ISM.

10. The method of claim 1, wherein said wireless transmitter transmits to said wireless receiver using near field communication.

11. The method of claim 1, wherein said wireless transmitter transmits to said wireless receiver using at least one protocol chosen from the group consisting of near field communication ISO/IEC 18092/ECMA-340 and near field communication ISO/IEC 21481/ECMA-352.

12. The method of claim 1, wherein said one or more processing units comprise a processing unit housed within said mobile device.

13. The method of claim 1, wherein said one or more processing units comprise a processing unit located at a remote location.

14. The method of claim 13 wherein said mobile device comprises means to communicate with said processing unit located at a remote location.

15. The method of claim 1, wherein said at least one database comprises a database stored within said mobile device.

16. The method of claim 1, wherein said at least one database comprises a database stored at a second remote location.

17. The method of claim 16, wherein said mobile device comprises means to communicate with said database stored at a second remote location.

18. The method of claim 17, wherein the remote location and the second remote location are substantially the same location.

19. The method of claim 16, wherein said processing unit located at a remote location comprises means to communicate with said database stored at a second remote location.

20. The method of claim 17, wherein the remote location and the second remote location are substantially the same location.

21. A method for controlling access by a requesting user to a peripheral device comprising a wireless receiver, comprising:
acquiring, by operation of a touch sensitive unit on a mobile device comprising a wireless transmitter, user input;
transmitting said user input via said wireless transmitter to the peripheral device comprising a wireless receiver;
extracting, by one or more processing units, user biometric information from at least said user input;
evaluating the degree of similarity of the user biometric information with at least one database comprising access-approved biometric information;
making an authorization decision with respect to the requesting user based on said degree of similarity;
generating, by the one or more processing units, a command corresponding to the user input; and
instructing said peripheral device comprising a wireless receiver to carry out said command.

22. The method of claim 21, wherein said touch sensitive unit comprises at least one touch sensitive device chosen from the group consisting of a touchscreen, a touchpad, an electronic pen, an accelerometer, and a digitizing tablet.

23. The method of claim 21, wherein said mobile device comprises at least one mobile unit chosen from the group consisting of a cellular phone, portable computer, a tablet computer, a laptop computer, a remote control, and an electronic pen.

24. The method of claim 21, wherein evaluating the degree of similarity is carried out using one or more machine-learning algorithms.

25. The method of claim 24, wherein at least one of said one or more machine-learning algorithms is chosen from the group consisting of neural networks algorithms, heuristic algorithms, support vector machine algorithms, and k-nearest neighbor (k-NN) algorithms.

26. The method of claim 21, wherein said wireless transmitter transmits information using electromagnetic radiation and said wireless receiver receives said information.

27. The method of claim 26, wherein said electromagnetic radiation comprises frequencies ranging between roughly 3 kiloHertz and 300 gigaHertz.

28. The method of claim 26, wherein said electromagnetic radiation comprises wavelengths ranging between roughly 0.1 and 10 microns.

29. The method of claim 26, wherein said wireless transmitter transmits to said wireless receiver using at least one protocol chosen from the group consisting of near field communication, IEEE 802.11, Bluetooth, and ISM.

30. The method of claim 21, wherein said wireless transmitter transmits to said wireless receiver using near field communication.

31. The method of claim 30, wherein said wireless transmitter transmits to said wireless receiver using at least one protocol chosen from the group consisting of near field communication ISO/IEC 18092/ECMA-340 and near field communication ISO/IEC 21481/ECMA-352.

32. The method of claim 21, wherein said one or more processing units comprise a processing unit housed within said peripheral device.

33. The method of claim 21, wherein said one or more processing units comprise a processing unit located at a remote location.

34. The method of claim 21, wherein said peripheral device comprises means to communicate with said processing unit located at a remote location.

35. The method of claim 21, wherein said at least one database comprises a database stored within said peripheral device.

36. The method of claim 21, wherein said at least one database comprises a database stored at a second remote location.

37. The method of claim 36, wherein the remote location and the second remote location are substantially the same location.

38. The method of claim 36, wherein said peripheral device comprises means to communicate with said database stored at a second remote location.

39. The method of claim 33, wherein said processing unit located at a remote location comprises means to communicate with said database stored at a second remote location.

40. The method of claim 39, wherein the remote location and the second remote location are substantially the same location.
